(19) United States
(12) Patent Application Publication
(10) Pub. No.: US 2025/0106286 A1
(43) Pub. Date: Mar. 27, 2025

(54) METHOD FOR FORWARDING DATA IN A COMMUNICATION SYSTEM OF A VEHICLE

(71) Applicant: Robert Bosch GmbH, Stuttgart (DE)

(72) Inventors: Basti Anil Shenoy, Hemmingen (DE); Benedikt Arthur Maximilian Mansbart, Kista (SE); Daniel Selig, Leonberg (DE); Hongyan Zhang, Stuttgart (DE); Joshua Rambo, Wixom, MI (US); Mikkel Liisberg, Stuttgart (DE); Samir Hamzaoui, Stuttgart (DE); Scott Chemello, Northville, MI (US); Stephan Rittler, Urbach (DE); Ulrich Stech, Neckarsulm (DE)

(21) Appl. No.: 18/836,462

(22) PCT Filed: Jan. 26, 2023
(86) PCT No.: PCT/EP2023/051850

§ 371 Date: Aug. 7, 2024

(30) Foreign Application Priority Data
Mar. 10, 2022 (DE) 10 2022 202 389.7

(51) Int. Cl. H04L 67/12; G06F 8/35; G06F 8/41; H04L 12/40

(52) U.S. Cl. CPC H04L 67/12; G06F 8/35; G06F 8/41; H04L 12/40; H04L 2012/40273

(57) ABSTRACT

A method for forwarding data in a communication system of a vehicle. The communication system includes at least a first bus system and at least one further bus system. The data can be exchanged between the bus systems, with at least one first domain as an independent execution instance, in particular an AUTOSAR domain. Application programs, in particular vehicle functions, can be executed in the first domain. The first domain includes at least standardized interfaces, in particular AUTOSAR real-time environment, to the application programs. Via a further domain as further execution instance independent of the first domain, data are exchanged between the communication system and the first domain by only the further domain accessing the physical interface of the communication system. Data received in the further domain via the physical interface of the communication system are processed at least with regard to forwarding.

### FIELD

The present invention relates to a method for forwarding data in a communication system of a vehicle.

### BACKGROUND INFORMATION

AUTOSAR (automotive open system architecture) is a development partnership between automotive manufacturers, control unit manufacturers and manufacturers of development tools, basic control unit software and microcontrollers, whose goal is to facilitate the exchange of software on various control units.

AUTOSAR provides a series of specifications that describe basic software modules, define application interfaces, and create a common development methodology on the basis of a standardized exchange format. Basic software modules provided by the AUTOSAR layered software architecture can be used in vehicles of different manufacturers and in electronic components of different suppliers.

U.S. Patent No. 8,966,443 describes a method for bypassing an AUTOSAR software component of an AUTOSAR software system.

An object of the present invention is to further improve the processing speed, in particular of an AUTOSAR software system. The object is achieved by certain features of the present invention.

### SUMMARY

A method according to features of the present invention makes it possible, precisely for control units with integrated gateway functionality, to forward or route certain data performantly. By correspondingly outsourcing the routing functionality to the further domain, the first domain, in particular the AUTOSAR domain, can be relieved. This results in better load balancing in the entire system and in better utilization of hardware resources, in particular when utilizing multi-core controllers. Through the proposed hybrid software architecture in the form of different domains and task distribution according to the present invention, it is possible on the one hand to retain the software in the AUTOSAR domain unchanged for fulfilling the hosting of vehicle functions, while the software on the further domain can be optimized precisely with regard to the performance capability of forwarding the data and thus for performance-relevant use cases. Due to the proposed distribution of functions into different domains and thus different execution instances according to the present invention, these functions can be flexibly distributed over one or more CPU cores depending on the system requirements and design. In particular when the vehicle is driven, low routing latency can be achieved due to the proposed solution. This is inter alia achieved in that the data exchange with the first domain is always carried out via the further domain, which is characterized by powerful forwarding mechanisms. Particularly expediently, the performance-relevant data remain in the further domain for further processing, while the further data are forwarded by the first domain.

In an expedient development of the present invention, a separate further domain is used for a first bus system and a further separate domain is used for a further bus system, wherein data exchange between the two further domains takes place only at the level of a data unit, in particular a protocol data unit (PDU), in particular a generic data unit and/or a data unit contained in a container. Precisely these routing mechanisms are extensively applied to application data exchanged between vehicle functions on various control units when the vehicle is driving in normal operation.

In an expedient development of the present invention, it is provided that data may be exchanged between the first and the further domain at the level of frames and/or at the level of a data unit, in particular by using a memory shared by both domains, while data are exchanged between one of the further domains and another of the further domains only at the level of the data unit but not at the level of the frame. A function-independent and protocol-independent data exchange mechanism can thus be used. This can achieve that the interfaces defined in the AUTOSAR standard can be retained so that the integration of the first domain into the overall system is simplified or can be retained as usual. The data exchange within the further domains on the basis of the data unit can be carried out particularly quickly and performantly.

In an expedient development of the present invention, it is provided that the further domain comprises at least one driver for connection to the physical interface of the communication system, in particular bus system, in particular for data access or control mechanisms for ISO/OSI layer 2, and/or that the further domain comprises at least one protocol memory or protocol stack, in particular for data access or control mechanisms for ISO/OSI layers 3-5 required for handling performance-relevant data from the further domains, and/or that the further domain comprises at least one gateway for forwarding at least one data unit, in particular between protocol stacks of different further domains. On the one hand, this ensures communication only via the further domain. In addition, performant handling of the performance-relevant use cases can be carried out, such as processing non-transport protocols to extract the data units for performant routing.

In an expedient development of the present invention, it is provided that, in the first, in particular AUTOSAR, domain, a virtual driver, in particular as proxies of real drivers, is provided for exchanging frames between the first and the further domain with the corresponding driver of the further domain and/or for exchanging with an interface, provided in the first domain, for frames, and/or that, in the first domain, at least one adapter is provided for exchanging data or data units with the gateway of the further domain and/or for exchanging with a router, provided in the first domain, for the data units. This ensures that direct access to physical communication interfaces is limited to the further domain. However, via the virtual interfaces, the corresponding integration of the further domain can be considered, in particular in the AUTOSAR architecture definition. Via the adapter, data exchange with the further domain can be ensured at the level of the data unit.

In an expedient development of the present invention, it is provided that a configuration code relating to the forwarding of the data in the further domain and/or a reduced system description of the first domain, in particular a reduced AUTOSAR control unit extract, is or are generated from a system description of the first domain, in particular a complete AUTOSAR control unit extract. An existing tool chain can thus be modified in order to derive the corresponding domain-specific configurations from the complete control unit configuration. Automated software generation can thus take place for the two domains. This is tool support for processing in particular AUTOSAR standard inputs (control unit extract in ARXML format) for configuring the software of both the AUTOSAR domain and the further domain.

In an expedient development of the present invention, the configuration code is generated using a data model describing the forwarding of the data. The data model can be used to store and visualize data for the routing setup of the further domain that was extracted from the control unit extract.

Further expedient developments of the present invention arise from the disclosure herein.

### BRIEF DESCRIPTION OF THE DRAWINGS

FIG. 1 shows a classical E/E architecture of a motor vehicle.

FIG. 2 shows a domain E/E architecture of a motor vehicle.

FIG. 3 shows a central E/E architecture of a motor vehicle,

FIG. 4 shows an abstract representation of the hybrid software architecture.

FIG. 5 shows a schematic representation of the data structure.

FIG. 6 shows the various data paths in the hybrid software architecture.

FIG. 7 shows the data paths for routing PDU and container within one of the further domains.

FIG. 8 shows the data paths relating to the reception portion for routing PDU and container between two of the further domains.

FIG. 9 shows the data paths relating to the transmission portion for routing PDU and container between two of the further domains.

FIG. 10 shows the data paths for receiving and transmitting frames through the AUTOSAR domain.

FIG. 11 shows the data paths for receiving and transmitting PDUs through the AUTOSAR domain.

FIG. 12 shows the data paths for PDU reception by an application and PDU routing.

FIG. 13 shows a tool and workflow for the hybrid software architecture.

FIG. 14 shows a data model of the routing setup.

### DETAILED DESCRIPTION OF EXAMPLE EMBODIMENTS

The present invention is shown schematically on the basis of an exemplary embodiment and is described in detail below with reference to the figures.

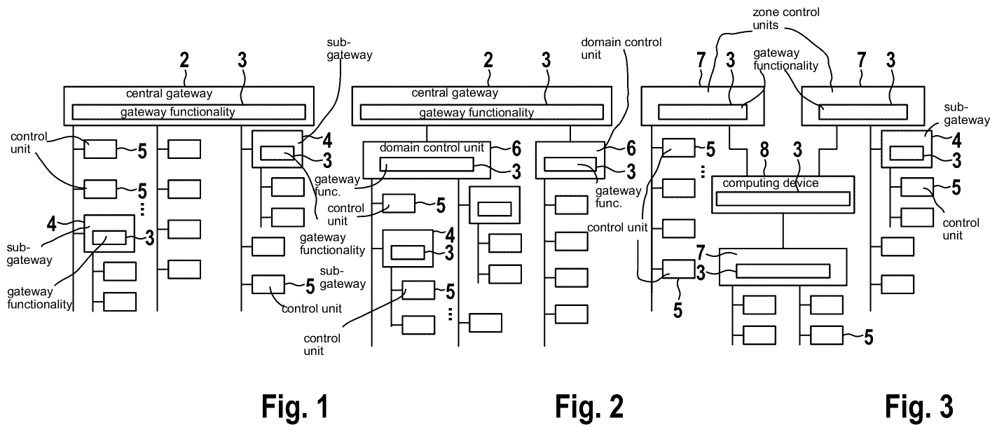

In the automotive context, the electrical and electronic architecture (E/E) of vehicles comprises a network of electronic control units 5 interconnected via communication channels. These E/E architectures are designed such that the exchange of information between the control units 5 is limited. This limitation of the information is technically carried out by a gateway functionality 3, which is integrated as a pure software or software/hardware solution in certain control units 2, 4, 6, 7, 8 at communication interfaces in the vehicle. The task of the gateway 3 is to interconnect communication channels of the same or different vehicle bus technologies (for example, CAN, LIN, Flexray, Ethernet, or similar) and to make controlled transmission of communication messages possible between them. Various E/E architectures are shown in FIGS. 1-3.

The classical E/E architecture according to FIG. 1 is characterized by a central gateway 2 with gateway functionality 3, the central gateway interconnecting multiple communication channels, to which control units 5 are respectively connected. Subgroups of control units 5 can in turn be interconnected by data technology with gateway functionality 3 via a sub-gateway 4.

In a domain-related E/E architecture according to FIG. 2, the central gateway 2 is again provided, which interconnects multiple domain control units 6 with gateway functionality 3 contained therein, for the purpose of data exchange. Via the domain control units 6, further control units 5 or, depending on the architecture, sub-gateways 4 with control units 5 connected thereto can be provided for the purpose of data exchange.

In the zone-relative E/E architecture according to FIG. 3, multiple zone control units 7 with gateway functionality 3 are provided, which can be arranged, for example, at different locations in the motor vehicle. The zone control units 7 are interconnected via a computing device 8, in particular a powerful vehicle computer, for the purpose of data exchange. For this purpose, the computing device 8 likewise comprises a gateway functionality 3. Via the zone control units 7, further control units 5, which are arranged spatially (for example, on the left front, on the right front, on the rear side, etc. in the vehicle) in the area of this zone, are connected by data technology. Depending on the application, sub-gateways 4 may also be provided for connecting further control units 5.

The main use case of most control units 5 is to host application software components for realizing various vehicle functions (for example, braking, engine control, power management, etc.). In order to make this easier, an automotive standard for software architecture has been defined in AUTOSAR. AUTOSAR defines standard interfaces to the application software components in a real-time environment (also abbreviated to RTE) and the corresponding infrastructural mechanisms, such as operating system, communication, diagnostics, non-volatile data storage, in the basic software, etc. It is therefore advantageous to retain the standardized approach with the AUTOSAR standard software for this use case.

However, for control units with integrated gateway functionality 3, powerful data handling, such as performant forwarding of communication messages, etc., must be fulfilled. Although the required routing functionality is defined and supported by the AUTOSAR standard, the routing performance in the AUTOSAR standard software is often not sufficient to fulfill the performance requirements as defined by vehicle manufacturers, for example. As a result of the standardization of software architecture, functionality, and interfaces through AUTOSAR and liability issues for changes to standard software, the ability to optimize software for performance is limited. In addition, the different communication paradigms and routing mechanisms of the vehicle manufacturers provide additional optimization potential via vehicle-manufacturer-specific solutions that cannot be utilized with AUTOSAR standard software. The AUTOSAR standard software is thus not optimal for implementing the gateway functionality 3.

In the following exemplary embodiments, the gateway functionality 3 is described in more detail, which makes powerful data handling or data routing for an AUTOSAR environment possible. For control units 5 that must fulfill both use cases (hosting of vehicle functions) and gateway functionality 3, a powerful software architecture and complete software solution is proposed. This is referred to as a hybrid multi-core software architecture for automotive controllers with integrated gateway functionality 3.

The hybrid software architecture is divided into independent execution instances, hereinafter referred to as domains 16, 18, 20; 40, 42, 44. These domains 16, 18, 20; 40, 42, 44 are independently executable and are characterized by different partitions, in particular software partitions. The communication between different domains 16, 18, 20; 40, 42, 44 takes place either via corresponding interfaces or, for example, via a particular memory concept (shared memory: for example, a ring buffer, which the different domains 16, 18, 20; 40, 42, 44 may access according to certain rules (writing/reading; memory areas, etc.) for the purpose of data exchange. In multi-core CPU systems (microcontroller or microprocessor or system-on-chip SOC), these domains can be flexibly distributed over one or more CPU cores depending on control unit system requirements and design. A generic data exchange mechanism, as inter-domain communication 30, 66 between at least the first domain 40, 42, 44, in particular AUTOSAR domain, and the further domain 16, 18, 20, in particular communication domain, makes it possible to exchange data between the domains 16, 18, 20; 40, 42, 44 and cores or within the computer cores.

An additional partitioning of the software architecture into independent execution units, hereinafter referred to as domains 16, 18, 20; 40, 42, 44, is introduced. These domains 16, 18, 20; 40, 42, 44 have corresponding execution functions, which can be flexibly integrated as cyclic tasks or interrupts into the operating system planning in order to realize the required control unit system behavior.

The portion of the AUTOSAR architecture is assigned to at least one (first) domain 40, 42, 44 or, depending on the use case, multiple (first) domains 40, 42, 44, which is referred to as first or AUTOSAR domain 40, 42, 44 below and is fully compliant with the AUTOSAR standard and is not changed. This AUTOSAR domain 40, 42, 44 can be realized as an AUTOSAR single-core or multi-core architecture. In the AUTOSAR domains 40, 42, 44, different application programs 46 may be provided depending on the application, shown, by way of example, as vehicle function programs 48.1, 48.2, . . . , 48.n. Furthermore, the particular AUTOSAR domain 40, 42, 44 comprises a basic software 52, which may, for example, comprise a router, in particular a PDU router 54 (I-PDU: interaction layer protocol data unit, a data unit defined by AUTOSAR, hereinafter also referred to as a PDU (protocol data unit) or data unit) and/or interfaces 56 for bus systems used (for example, CAN, Flexray, Ethernet, etc.).

Regardless of the at least one (first) AUTOSAR domain 40, 42, 44, at least one further domain 16, 18, 20 is provided, preferably multiple further domains 16, 18, 20. The further domain 16, 18, 20 has an independent execution function, which relates to the routing and handling of data. Particularly preferably, a separate domain 16, 18, 20 is provided for each communication protocol (of the particular communication system 11), for example a CAN domain 20, a Flexray domain 18, an Ethernet domain 16, etc. The further domain 16, 18, 20 accesses the corresponding physical interface 13 of the communication system 11 and processes messages of the corresponding communication system 11.

The functional division between the AUTOSAR domain 40, 42, 44 and the further domain 16, 18, 20, in particular for routing data, is carried out such that performance-relevant use cases, which are characterized by fast routing or forwarding of data, are assigned to the further domain 16, 18, 20. A large part of the entire data forwarding that is to be realized by the gateway 3 in control units utilizes the so-called PDU and container routing mechanism. This routing mechanism is extensively applied to application data exchanged between vehicle functions on control units 5 when the vehicle is driving (normal operation). This use case has a high requirement for low routing latency and is therefore assigned to the further domain(s) 16, 18, 20 for routing or forwarding data. The forwarding of the data in the further domain 16, 18, 20 takes place in conjunction with in the data unit PDU 72 or container 74, in particular through information in the header 80 and forwarding information such as is stored in routing tables, for example. Via the header 80 or its associated information, identification is possible as to how the following payload data 82 are to be interpreted or forwarded.

All other use cases or standard cases, such as diagnostic tasks or the like, which are not characterized by fast data forwarding, are assigned to the AUTOSAR domain 40, 42, 44. All remaining use cases, such as local scheduling (reception and transmission by hosted vehicle functions), transport protocols (ISO-TP (International Standards Organization-transport protocol), TCP (transmission control protocol), diagnostic communication and diagnostic routing (UDS (unified diagnostic services), OBD (on-board diagnostics), DolP (diagnostics over internet protocol)), network management, etc. are assigned to the AUTOSAR domain 40, 42, 44.

The domains 16, 18, 20; 40, 42, 44 in the hybrid software architecture may be mapped to one or more CPU cores in multi-core CPU systems (microcontroller or microprocessor or system-on-chip (SoC)) in order to fulfill the control unit requirements and the design (e.g., number of interfaces, data traffic, latency and throughput requirements, CPU load through routing, . . . ).

The first or AUTOSAR domain 40, 42, 44 may be realized as a single-core or multi-core implementation as defined by the AUTOSAR standard.

The further domains 16, 18, 20 specific to communication protocols can be flexibly mapped to CPU cores in order to realize single-core or multi-core implementations. Each further domain 16, 18, 20 may be assigned to a different CPU core (e.g., CAN core, Ethernet core, . . . ), or multiple or all further domains 16, 18, 20 may be assigned to a single core (e.g., CAN, Flexray, and Ethernet on a single core).

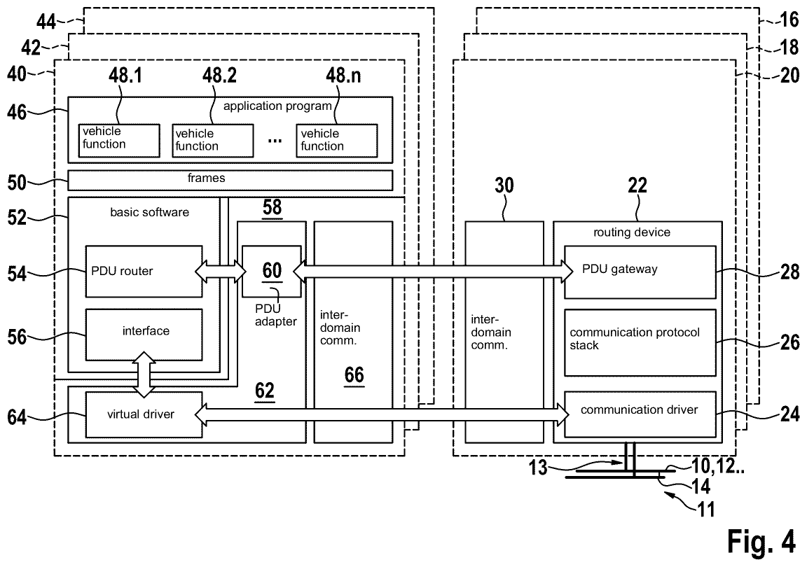

The exchange of communication data between the AUTOSAR domain 40, 42, 44 and the further domains 16, 18, 20 takes place via a generic data exchange mechanism, which is, for example, based on the shared memory concept as described above and is referred to as inter-domain communication 30, 66, located in the communicating first and further domains 16, 18, 20; 40, 42, 44 as indicated in FIG. 4.

Inter-domain communication 30, 66 is a function-independent and protocol-independent data exchange mechanism, which makes the transmission of data blocks from a transmitter to one or more receivers possible.

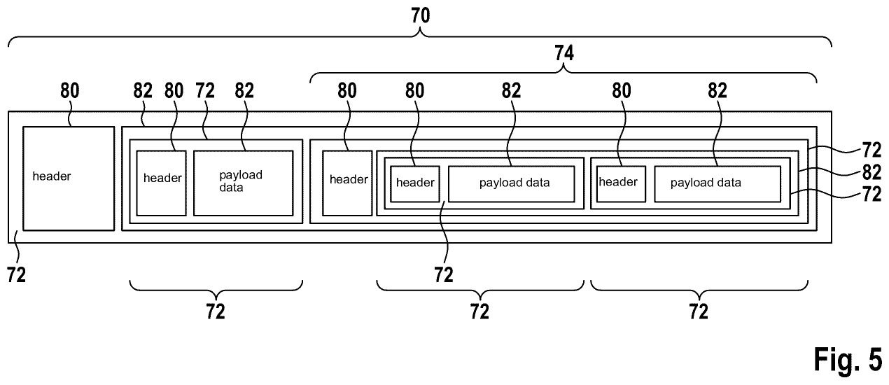

The data blocks (e.g., payload data 82 according to FIG. 5) are accompanied by additional meta-information (e.g., header 80 according to FIG. 5), namely, for example, their identifier and length, which make it possible for the transmitters and receivers to interpret the exchanged data together. The scheduling of the data exchange can be configured via polling or interrupt scheme. The exchanged data may additionally be protected by security mechanisms, such as authentication, in order to ensure data integrity.

If the areas between which data are exchanged are mapped to different cores depending on the control unit design, the same data exchange mechanism is referred to as inter-core communication.

In the context of this application, the data units of frame 70, PDU 72 and container 74 are relevant according to FIG. 5. The format of these data units follows a TLV scheme (type, length, value). The type (identifier, additional protocol parameters) and the length (of the payload data 82 or payload in bytes) are meta-information, are collectively referred to as header 80 and indicate the content of the value (payload data 82 or user data).

A frame 70 is the data unit that is transmitted via the physical interface 13 of a particular communication protocol and the exact format of which is defined by the protocol (CAN, Flexray, Ethernet).

A PDU 72 corresponds, in whole or in part, to the payload data 82 of the frame 70 containing the application data (from signals with physical or functional relevance, e.g., vehicle velocity, ambient temperature, error status flag, . . . ). The PDU 72 has its own header 80 and payload or payload data 82.

A container 74 for PDU 72 is a collector used to group multiple contained PDUs 72. PDUs 72 transmitted in frames 70 without a container 74 are referred to as generic PDUs 72. Container 74, PDUs 72 contained in the container 74, and generic PDUs 72 have their respective headers 80 and payload or payload data 82. These data units may have a nested structure in which frames 70 are composed of generic PDUs 72 and/or container PDUs 72, and container PDUs 72 themselves are composed of PDUs 72 contained in containers 74, as shown, by way of example, in FIG. 5.

In order to comply with the interfaces defined in the AUTOSAR standard (APIs: application programming interfaces), data can be exchanged between the further domains 16, 18, 20 and the AUTOSAR domain 40, 42, 44 at the levels of the data unit: frame 70 (cf. FIG. 4, the lower double arrow between communication driver 24 of the further domain 16, 18, 20 and the virtual drivers 64 of the first domains 40, 42, 44) and PDU 72 (generic PDU 72 and one contained in the container 74; indicated in FIG. 4 by the upper double arrow between the PDU gateway 28 and the PDU adapter 60, forwarded to the PDU router 54 of the first domain 40, 42, 44).

In order to comply with the data units exchanged with the AUTOSAR domain 40, 42, 44, data may be exchanged between the further domains 16, 18, 20 only at the level of the data unit PDU 72 (generic PDU 72 and/or one contained in the container 74). The data exchange between two further domains 16, 18, 20, which are based on different communication protocols (CAN, Flexray, Ethernet), is not possible at the frame level due to the different frame layout of the corresponding protocols.

Within the hybrid software architecture, direct access to physical communication interfaces 13 of CAN, Flexray, and Ethernet protocols is limited to only the corresponding further domain 16, 18, 20, which relate to the routing or forwarding of data. This approach makes it possible for the further domains 16, 18, 20 to receive messages directly from the interfaces 13 and to disconnect within a short time. The messages are kept in the corresponding further domain 16, 18, 20 for further processing and the remaining messages are forwarded to the AUTOSAR domain 40, 42, 44. The AUTOSAR domain 40, 42, 44 thus does not have direct access to the interfaces 13 of the corresponding communication systems 11 but receives relevant messages indirectly via the corresponding further domain 16, 18, 20.

The software architecture of the further domains 16, 18, 20, which are specifically provided for the corresponding communication protocols (CAN, Flexray, Ethernet), is structured similarly (see FIG. 4). A routing device 22 for the corresponding further domain 16, 18, 20 is in each case composed of a communication driver 24 for connection to the corresponding physical interface 13 of the communication system 11, a communication protocol stack 26 and/or memory stack for handling the higher protocol layers (e.g., CAN/FR/ETH . . . ), and the protocol-independent PDU gateway 28 for forwarding PDUs 72. An instance of the inter-domain communication 30 is required for the data exchange with other (further) domains 16, 18, 20 or the AUTOSAR domains 40, 42, 44.

The communication drivers 24 implement ISO/OSI layer 2-related data access (reading and writing) and control mechanisms (mode and fault management) necessary for handling the communication controllers and physical interfaces 13 of the corresponding communication protocol (CAN, Flexray FR, Ethernet ETH, . . . ).

The communication protocol stack 26 or communication protocol memory implements only the ISO/OSI layers 3-5 data access and control mechanisms necessary for handling the routing-relevant use cases on the further domains 16, 18, 20. This area comprises primarily the processing of non-transport-protocol messages (non-ISO-TP, UDP) to extract PDUs 72 for performant routing.

The PDU gateway 28 carries out performant forwarding of PDUs 72 between various data sources and data sinks, namely, the local communication protocol stack 26, the communication protocol stack 26 on other further domains 16, 18, 20, and/or the AUTOSAR domain 40, 42, 44 via the inter-domain communication 30. This forwarding is controlled by configurable routing instructions, which are also referred to as the routing table. The forwarding may take place on the basis of the particular header 80.

In order to exchange data with other further domains 16, 18, 20 and the AUTOSAR domain 40, 42, 44, an instance of the inter-domain communication 30 is executed in each of the further domains 16, 18, 20.

AUTOSAR is a standalone and complete standard architecture. In order to integrate the proprietary routing architecture into AUTOSAR, software modules 58, 60, 62, 64 located on the first domain 40, 42, 44 and directly connected to any AUTOSAR standard modules 52, 54, 56 must be introduced and incorporated into the AUTOSAR architecture definition of the control unit. The AUTOSAR standard provides the ability to use complex device drivers 58 (CDD) for such integrations.

In the AUTOSAR standard architecture, drivers of communication interfaces (CAN/Flexray/Ethernet drivers) are part of the microcontroller abstraction layer (MCAL) architecture layer. Since, within the hybrid software architecture, direct access to physical communication interfaces 13 is limited to the further domains 16, 18, 20, the MCAL on the AUTOSAR domain 40, 42, 44 must be switched off for corresponding protocols via so-called virtual communication drivers or virtual drivers 64 (CDD). As the name implies, the virtual drivers 64 are not real drivers but proxies of the real drivers and serve as standard AUTOSAR APIs with respect to the superordinate interface modules (CAN/Flexray/Ethernet interface) of the so-called control unit abstraction layer (ECU abstraction layer (ECUAL)). The virtual drivers 64 interact and exchange frames 50 with their counterparts, namely, with the real communication drivers 24 on the corresponding further domains 16, 18, 20, via the inter-domain communications 30, 66, which is also located as a counterpart on the AUTOSAR domain 40, 42, 44.

In the AUTOSAR standard architecture, a PDU router 54 is the software module in which PDUs 72 are forwarded between different software modules of the lower and upper layers. In order to be able to exchange PDUs 72 between AUTOSAR domains 40, 42, 44 and the further domains 16, 18, 20, the driver CDD (AUTOSAR complex device driver) referred to as PDU adapter 60 is incorporated as a lower level module of the AUTOSAR PDU router 54 into the architecture. The PDU adapter 60 interacts and exchanges PDUs 72 with the PDU gateway 28 of the corresponding further domain 16, 18, 20 via the inter-domain communication 30, 66. This takes place through the aforementioned shared memory architecture, i.e., a common memory, such as a circular buffer.

An instance of the inter-domain communication 66 is executed in the AUTOSAR domain 40, 42, 44 in order to make data exchange with counterparts on the further domains 16, 18, 20 possible. Receiving and transmitting frames 70 and PDUs 72 in the AUTOSAR domain 40, 42, 44 are made possible by forwarding these data units from or to the virtual communication drivers 64 (at the frame level) or PDU adapter 60 (at the PDU level). However, in contrast to the virtual communication drivers 64 and the PDU adapter 60, the inter-domain communication 66 must not be incorporated into the AUTOSAR architecture definition since it is not directly connected to standard AUTOSAR modules 52, 54, 56.

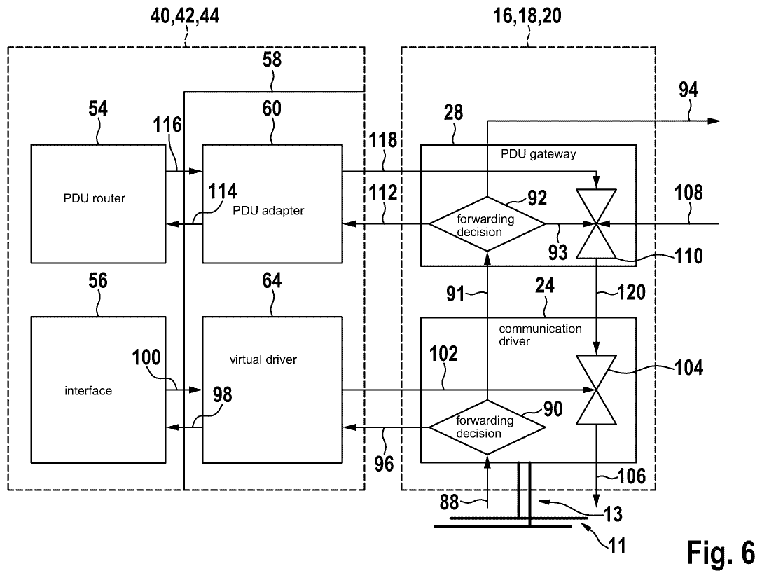

For addressing the hosting of the vehicle functions and gateway use cases 5, data from both data sources, namely, physical communication interfaces 13 and application software components, are forwarded in the hybrid software architecture along different data paths and processed, as can be seen in FIG. 6.

A forwarding decision 90 for received frames 70 is in each case located in the further domains 16, 18, 20 or associated communication drivers 24 in order to further process frames 70 that are received directly from the corresponding interfaces 13 (CAN, Flexray, Ethernet). The further domain 16, 18, 20 has an independent execution function, which relates to the routing of data. According to the configurable forwarding decision 90, by evaluating the header 80 for frames 70 within the communication driver 24, the frames 70 received (in step 88) are forwarded to one of the following targets:
for AUTOSAR domains 40, 42, 44 only: Frames 70, which are to be further processed only in the AUTOSAR domain 40, 42, 44, are forwarded only via the corresponding virtual driver 64 (CDD) to the AUTOSAR (CAN/Flexray/Ethernet) interface module 56.
for the further domains 16, 18, 20 only: Frames 70 with application-relevant PDUs 72 that are to be extracted and further processed are forwarded only upward (to the corresponding further domains 16, 18, 20) in the software stack 26 or communication protocol stack 26 within the further domain 16, 18, 20 (communication protocol stack 26 and PDU gateway 28).
for both AUTOSAR domains 40, 42, 44 and for further domains 16, 18, 20: For certain special cases, frames 70 are forwarded both to AUTOSAR domains 40, 42, 44 and upward in the software stack or communication protocol stack 26 of the further domains 16, 18, 20.

The forwarding decision 90 for received frames 70 can be summarized as follows:
for AUTOSAR domains 40, 42, 44 only
   diagnostic communication
      CAN/FR: UDS (unified diagnostic services) on ISO-TP (International Standards Organization-transport protocol)
      ETH (Ethernet): UDS on DoIP (diagnostics over internet protocol) (UDP, TCP (transmission control protocol))
   diagnostic forwarding
      CAN/FR: message routing of ISO-TP messages
      ETH: DoIP routing, non-diagnostic TCP channels
   non-diagnostic TCP channels
      relevant to CAN, FR, ETH:
   time synchronization, network management, measurement & calibration (XCP)
for the further domains 16, 18, 20 only
   frame 70 with PDUs 72 for PDU and container routing or/and reception by an application
relevant to AUTOSAR domains 40, 42, 44 and to the further domains 16, 18, 20
   relevant to ETH only:
      address resolution protocol (ARP)
      SOME/IP service discovery (SD)

Forwarding decision 92 for received PDUs 72 The frames 70 forwarded from the communication driver 24 upward in the software stack 26 are further processed in order to extract either generic PDUs 72 and/or container PDUs 72 that contain the atomically contained PDUs 72.

Generic PDUs 72 or contained PDUs 72 (in containers 74) are forwarded according to the configurable PDU forwarding decision 92 within the PDU gateway 28 to one of the following targets:
AUTOSAR domains 40, 42, 44 only: PDUs 72 relevant only to the reception by applications 46, 48 hosted in the AUTOSAR domain 40, 42, 44 are forwarded to the AUTOSAR PDU router 54 only via the PDU adapter 60.
only relevant to the further domains 16, 18, 20: PDUs 72 that are only relevant to PDU and container routing are forwarded:
   if the target interface 13 is located in the same further domain 16, 18, 20, back downward in the communication protocol stack 26 of the routing device 22 and communication driver 24 for transmission.
   if the target interface 13 is located in another further domain 16, 18, 20, to the PDU gateway 28 of the corresponding further domain 16, 18, 20 for transmission.
for both AUTOSAR domains 40, 42, 44 and further domains 16, 18, 20:
   PDUs 72 relevant to both reception by applications 46, 48 and PDU and container routing are forwarded to both the AUTOSAR domain 40, 42, 44 and the target domain of the further domain 16, 18, 20.

Combination of the transmission of PDUs 72 and frames 70 from AUTOSAR domains 40, 42, 44 and further domains 16, 18, 20:

Since only the further domains 16, 18, 20 have direct access to physical interfaces 13, transmission data from AUTOSAR domains 40, 42, 44 and further domains 16, 18, 20 must be combined and transmitted on the further domain 16, 18, 20 of the associated target interface 13 (CAN/Flexray/Ethernet).

PDUs 72 from application programs 46, 48 in the AUTOSAR
domain 40, 42, 44, from other further domains 16, 18, 20 and/or from the local further domain 16, 18, 20 are combined in the PDU gateway 28 of the local further domain 16, 18, 20 in order to construct the payload data 82 of the target frame 70.

Frames 70 from the basic software 52 in the AUTOSAR domain 40, 42, 44 and the local further domain 16, 18, 20 are transmitted from the communication driver 24 on the local further domain 16, 18, 20 to the target interface 13.

Data paths for different use cases based on the particular use case, a particular subset of the processing, forwarding decision, and data paths is relevant in the hybrid software architecture are relevant. The data paths for different use cases are explained in the following sections in connection with FIGS. 6-12.

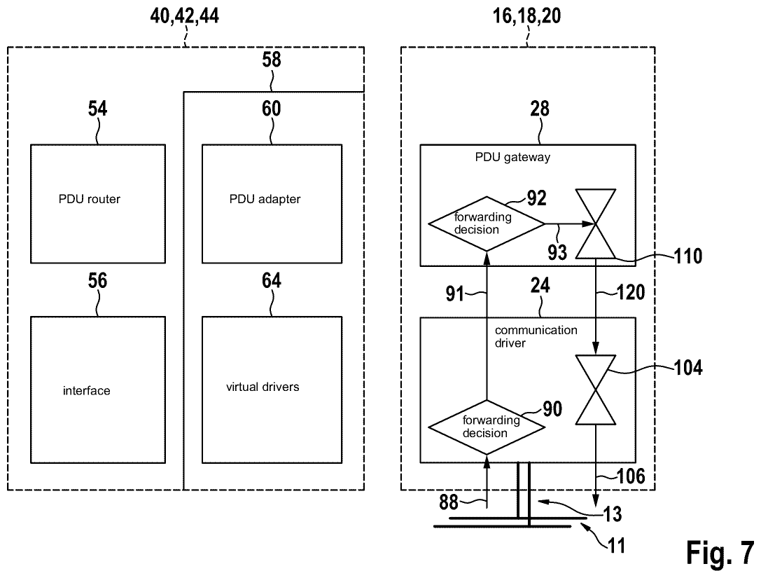

PDU and container routing within one of the further domains 16, 18, 20 is shown in FIG. 7. For this use case, the PDUs 72 and/or containers 74 (contained in frames 70 received in step 88) received on one of the further domains 16, 18, 20 are transmitted to the target interface 13 (transmission of a corresponding frame 70 according to step 106) of the same further domain 16, 18, 20 (e.g., CAN to CAN routing). The data path (steps 91, 92, 93, 110, 120) in the software stack 26 within a single one of the further domains 16, 18, 20 thus goes up and down without data exchange with AUTOSAR domains 40, 42, 44 and other further domains 16, 18, 20.

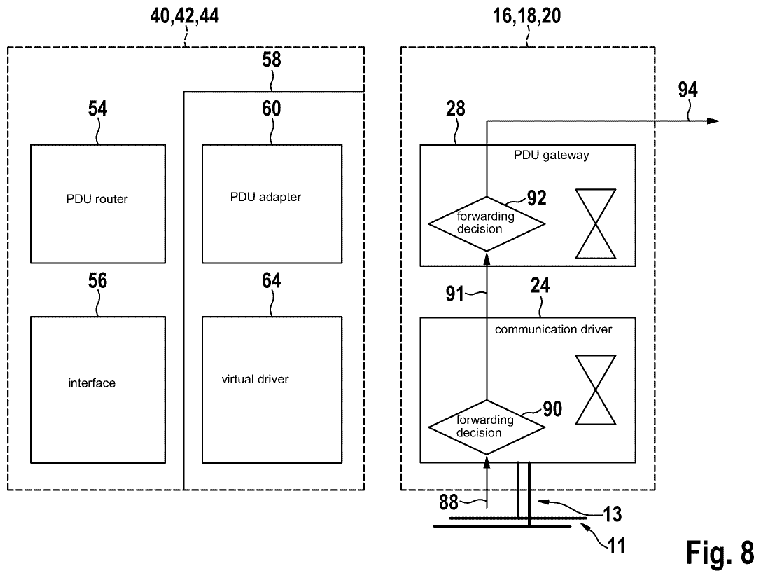

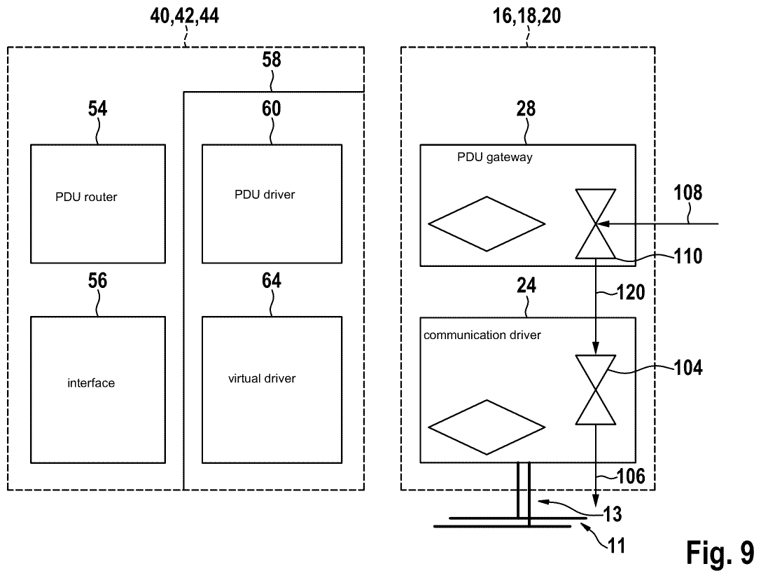

PDU and container routing between the further domains 40, 42, 44 is shown in FIG. 8 (reception portion) or FIG. 9 (transmission portion). For this use case (steps 88, 90, 91, 92, 94 (FIG. 8); steps 108, 110, 120, 104, 106 (FIG. 9)), the PDUs 72 and/or containers 74 received on the source domain 16, a (reception of the corresponding frames 70 in step 88, forwarding decision 90 for forwarding to the PDU gateway 28 or the forwarding decision 92 there when a PDU 72 is received, forwarding to the corresponding further target domain 16, 18, 20 in step 94; in the further target domain 16, 18, 20, the PDU 72 is received by the other further domain 16, 18, 20 in step 108; in step 110, combined transmission of the PDU 72 to the communication driver 24 of the target domain 16, 18, 20 takes place (step 120), wherein the communication driver 24 carries out a transmission of the PDU 72 in the associated frame 70 (step 104) and subsequently transmits to the associated interface 13 (step 106) to the target interface 13 of the target domain 16, 18, 20).

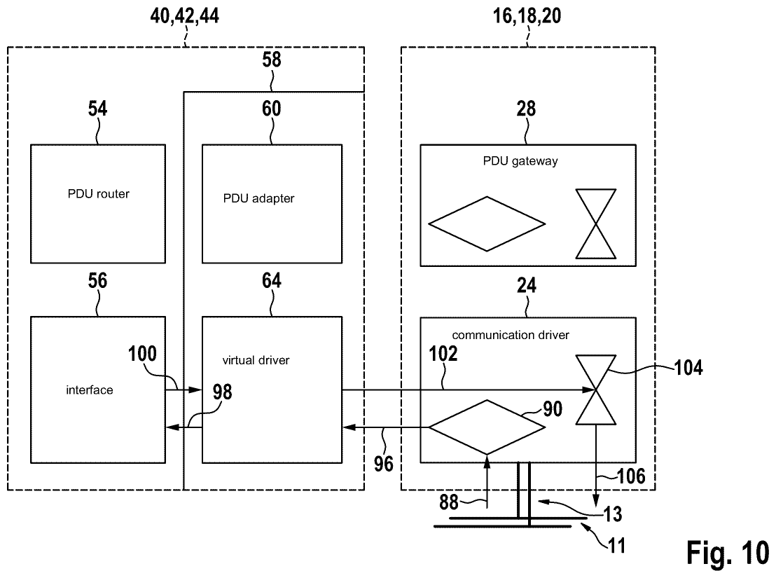

The reception and transmission of frames 70 and PDUs 72 by an AUTOSAR domain 40, 42, 44 is shown in FIG. 10. For this use case, the frame 70 received on one of the further domains 16, 18, 20 (step 88) and relevant to the AUTOSAR domain 40, 42, 44 (and ascertained as such in the forwarding decision 90, for example via the header 80 and the routing table) is transmitted (in step 96) from the communication driver 24 of the further domain 16, 18, 20 to the virtual driver 64 of the AUTOSAR domain 40, 42, 44. Likewise, the frames 70 to be transmitted from the AUTOSAR domain 40, 42, 44 are first transmitted into the target domain of the further domain 16, 18, 20 and then to the target interface 13. To this end, the corresponding virtual interface 56 transmits the particular frames 70 to the virtual driver 64 in step 100. The virtual driver 64, which is also located in the AUTOSAR domain 40, 42, 44, transmits the particular frame 70 in step 102 to the communication driver 24 of the associated target domain 16, 18, 20 and then passes via step 104 to the associated interface 13 (cf. step 106).

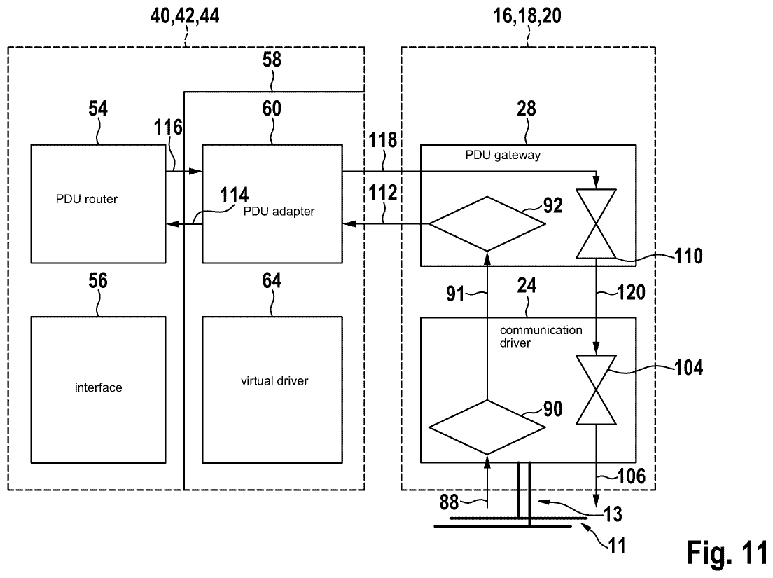

For the use case of receiving and transmitting PDUs 72 via AUTOSAR domains 40, 42, 44 (FIG. 11), generic PDUs 72 or contained PDUs 72, which are extracted from frames 70, and corresponding containers 74, which are received on one of the further domains 16, 18, 20, that are relevant to AUTOSAR domains 40, 42, 44 are transmitted into the AUTOSAR domain 40, 42, 44. The frames 70 received in step 88 are checked for relevance or routing in the forwarding decision 90 and are transmitted to the forwarding decision 92 of the PDUs 72 for the AUTOSAR domain 40, 42, 44 in step 91. In step 112, the transmission to the AUTOSAR domain 40, 42, 44 takes place via the PDU adapter 60 (via step 112) and the PDU router 54 (step 114). In a transmission of the PDU from the AUTOSAR domain 40, 42, 44, this takes place in step 116 from the PDU router 54 to the PDU adapter 60 and, in step 118, to the PDU gateway 28. In step 110, the transmission takes place and the PDUs 72 to be transmitted thus pass to the communication driver 24 in step 120, wherein, in step 104, a conversion to the associated frame 70 of the corresponding further domain 16, 18, 20 and subsequent transmission (step 106) to the corresponding interface 13 take place.

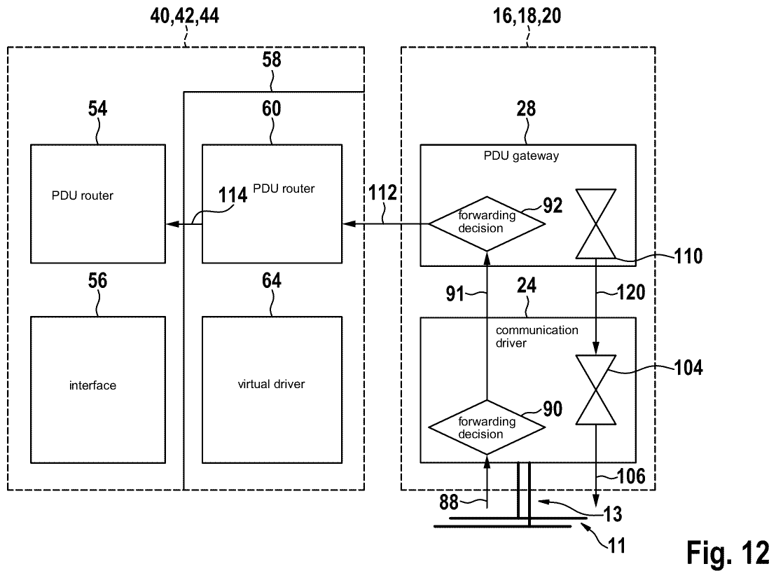

A combination of use cases is shown in FIG. 12. In addition to the three aforementioned use cases (forwarding decision for frames 70, forwarding decision for PDUs 72, combined transmission of PDUs 72 and frames 70 from AUTOSAR domains 40, 42, 44 and from further domains 16, 18, 20), a combination of these use cases is possible. An example of such a use case is a combination of reception of PDU 72 by an application 46, 48 and a PDU routing within the local further domain 16, 18, 20. In this case, the received PDU 72 is apportioned via the PDU forwarding decision 92 to the AUTOSAR domain 40, 42, 44 (via transmission paths 112, 140 with PDU adapter 60) and via the transmission path 93, 110, 120, 104 in the software stack 26 of the same further domain 16, 18, 20. Further such combinations of use cases are supported by the hybrid software architecture.

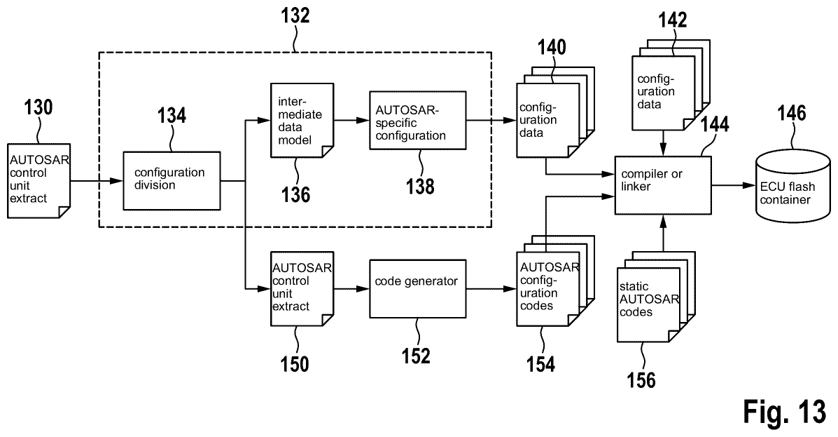

An off-board tool chain for integrating the further domains 16, 18, 20 for data routing is shown in FIG. 13. The implementation of the hybrid software architecture in embedded software must be supplemented by modifying the so-called off-board tool chain or development environment and the workflow for generating the control unit configuration and, accordingly, an ECU flash container 146. The hybrid software architecture substantially divides the full scope of the control unit functionality into AUTOSAR domain portions and further domain portions. The tool chain is therefore modified (see FIG. 13) in order to derive the AUTOSAR domain-specific and further domain-specific configurations from the full control unit configuration.

Through the configuration division 134 contained in the tool 132 for generating configuration data 140, 142 for the further domain 16, 18, 20, the AUTOSAR control unit configuration defined in the so-called complete AUTOSAR control unit extract 130 of the system description (*.arxml) is divided into a data-routing-specific configuration (as required for the further domains 16, 18, 20), which is stored in an intermediate data model 136 (of the further domain 16, 18, 20), and an AUTOSAR-specific configuration, which is a reduced AUTOSAR control unit extract 150. The content of the reduced AUTOSAR control unit extract 150 is thus that of the complete AUTOSAR control unit extract 130 reduced by the portion assigned to the data model 136 of the further domains 16, 18, 20 for data routing. The data routing configuration code (*.c, *.h) is generated from the data routing data model 136.

The tool 132 for generating configuration data for the further domain 16, 18, 20 is integrated at the entry point of the software development tool chain and of the workflow. The complete AUTOSAR control unit extract 130, for example of the vehicle manufacturer, is input into the tool 132 in order to derive the configuration code 140 and the reduced AUTOSAR control unit extract 150. This reduced AUTOSAR control unit extract 150, although reduced in scope, is consistent and can therefore be input into any AUTOSAR configuration tool and code generator 152 in order to generate an AUTOSAR configuration code 154. Static codes 142 (*.c, *.h) of the routing unit 22 (of the further domains 16, 18, 20) and static AUTOSAR codes 156 (*.c, *.h) and the configuration codes 140 of the routing unit 22 as well as the AUTOSAR configuration codes 154 are supplied to a compiler or linker 144, which compiles and links them in order to generate a complete control unit SW flash container 146, via which a software update can be flashed into the control unit 5.

The data model 136 of the routing unit of the further domains 16, 18, 20 is a compact control-unit-centered object model, the content of which is derived from the complex and redundant vehicle-centered AUTOSAR data model. The routing-unit-specific configuration is temporarily stored in the tool 132 in the format of the data model 136 of the routing unit of the further domains 16, 18, 20 before the configuration code 140 is generated. This format makes simpler visualization and analysis of data flow and communication relationships of the gateway 3 possible.

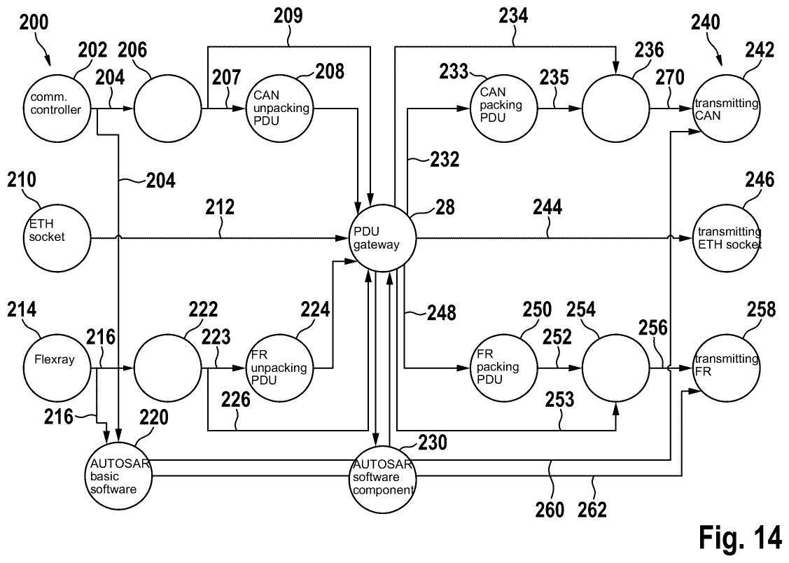

The data model 136 (see FIG. 14) represents the data flow in the gateway 3 in the form of a directed acyclic graph (DAG) consisting of vertices (nodes) connected to unidirectional edges (arrows). The endpoint vertices represent sources 200 and sinks 240 of data (communication controller 202 (receiving, e.g., CAN), 242 (transmitting, e.g., CAN); 214 (receiving, e.g., FR (Flexray), 258 (transmitting, e.g., FR), 210 (receiving, e.g., ETH socket), 246 (transmitting, e.g., ETH socket), AUTOSAR basic software 220, AUTOSAR software component 230). The intermediate vertices represent processing steps in the gateway (receiving (204 (receiving CAN frame), 207 (receiving CAN container PDU), 209 (receiving CAN generic PDU), 212 (receiving ETH generic/contained PDU), 216 (receiving FR frame), 223 (receiving FR container, PDU), 226 (receiving generic PDU)), unpacking (208 (CAN unpacking PDU), 224 (FR unpacking PDU)), in particular PDUs in CAN, FR, forwarding, packing (233 (CAN packaging PDU), 250 (FR packaging PDU)), transmitting (223 (transmitting CAN contained PDU, 248 (transmitting FR contained PDU), 235 (transmitting CAN container PDU), 252 (transmitting FR container PDU), 253 (transmitting FR generic PDU), 256 (transmitting FR frame), 260 (transmitting AUTOSAR CAN frame), 262 (transmitting AUTOSAR FR frame), 270 (transmitting CAN frame)), and the interconnected edges represent communication data units (frames 70, PDU 72, generic PDU 72), including their interrelations (PDU 72 of a frame 70) and their chronological order of processing. These vertices and edges additionally have properties that describe them in more detail.

The proposed hybrid multi-core software architecture for automotive controllers with integrated gateway functionality provides an optimal solution for the problem being addressed. It combines the advantages of the AUTOSAR standard software architecture with a proprietary routing unit software architecture in order to achieve the use cases of hosting vehicle functions or gateway functionalities (performant data forwarding). In addition to describing the required modification to the embedded software, the required extension and integration of the tool 132 is also described.

1-14. (canceled)

15. A method for forwarding data in a communication system of a vehicle, wherein the communication system includes at least a first bus system and at least one further bus system, wherein the data can be exchanged between the first bus system and the least one further bus system, with at least one first domain as an independent execution instance including an AUTOSAR domain, the method comprising:
executing application programs including vehicle functions in the first domain, the first domain including at least standardized interfaces, including an AUTOSAR real-time environment, to the application programs; and
exchanging data, via a further domain as a further execution instance independent of the first domain, between the communication system and the first domain by only the further domain accessing a physical interface of the communication system, wherein the data received in the further domain via the physical interface of the communication system are processed at least with regard to forwarding.

16. The method according to claim 15, wherein the data include at least one data unit including an AUTOSAR I-PDU or a protocol data unit, wherein the data unit can be contained in a frame transmitted via the physical interface and/or in a container contained in the frame, wherein the data unit and/or the container include at least one header and payload data including application data.

17. The method according to claim 15, wherein a separate further domain is used for the first bus system and a further separate further domain is used for the further bus system, wherein data exchange between the separate further domain and the first separate further domain takes place only at a level of a data unit including a generic data unit and/or a data unit contained in a container.

18. The method according to claim 15, wherein in the further domain, data are forwarded that relate to performance-relevant application data exchanged between vehicle functions on control units when the vehicle is driving.

19. The method according to claim 15, wherein data may be exchanged between the first domain and the further domain at a level of frames and/or at a level of a data unit, by using a memory shared by the first domain and the further domain, and data are exchanged between the further domain and another further domain only at the level of the data unit but not at the level of the frame.

20. The method according to claim 15, wherein performance-relevant data remain in the further domain for further processing, while further data are forwarded to the first domain.

21. The method according to claim 15, wherein frames forwarded from a communication driver to a protocol memory or protocol stack are further processed by the further domain, by extracting generic data units and/or data units contained in a container, from the frames and/or container.

22. The method according to claim 15, wherein use cases including local scheduling or transport protocols or diagnostic communication or diagnostic routing or network management are carried out in the first domain.

23. The method according to claim 15, wherein a forwarding decision for received frames makes a distinction as to: (i) whether frames with data units and/or containers are present for forwarding, and/or (ii) whether reception by an application is provided.

24. The method according to claim 15, wherein: (i) the further domain includes at least one driver for connection to the physical interface of the communication system for data access or control mechanisms for ISO/OSI layer 2, and/or (ii) the further domain includes at least one protocol memory or protocol stack for data access or control mechanisms for ISO/OSI layers 3-5 required for handling performance-relevant data on the further domain, and/or (iii) the further domain includes at least one gateway for forwarding at least one data unit between protocol stacks of different further domains.

25. The method according to claim 15, wherein: (i) in the first domain, at least one virtual driver, as proxies of real drivers, is provided: (a) for exchanging frames between the first and the further domain with a corresponding driver of the further domain, and/or (b) for exchanging with an interface provided in the first domain for frames, and/or (ii) in the first domain, at least one adapter is provided: (a) for exchanging data or data units with a gateway of the further domain and/or (b) for exchanging with a router provided in the first domain for the data units.

26. The method according to claim 15, wherein a configuration code relating to the forwarding of the data in the further domain and/or a reduced system description of the first domain, is generated from a system description of the first domain including a complete AUTOSAR control unit extract.

27. The method according to claim 15, wherein at least a configuration code of the further domain and a configuration code of the first domain are supplied to a compiler or linker to create a flash container of a control unit.

28. The method according to claim 26, wherein the configuration code is generated using a data model describing the forwarding of the data.
